(19) United States
(12) Patent Application Publication
(10) Pub. No.: US 2011/0320292 A1
(43) Pub. Date: Dec. 29, 2011

(54) SYSTEMS AND METHODS FOR OBTAINING DEBIT CARD CUSTOMER APPROVAL OF OVERDRAFT FEES

(76) Inventor: Donald R. Perdue, Jefferson City, MO (US)

(21) Appl. No.: 13/170,822

(22) Filed: Jun. 28, 2011

Related U.S. Application Data
(60) Provisional application No. 61/359,097, filed on Jun. 28, 2010.

(51) Int. Cl. G06Q 20/00; G06Q 30/00

(52) U.S. Cl. 705/16

(57) ABSTRACT

A method for approving a transaction requested by a debit card customer at a point of sale (POS) terminal when completion of the transaction will overdraft a bank account with which the debit card is associated and the debit card customer is permitted to overdraft the bank account is disclosed. The method includes transmitting a denial of the transaction to the POS terminal and transmitting an overdraft approval indication to the POS terminal. The method includes receiving an overdraft request from the debit card customer via the POS terminal and transmitting an overdraft approval and information regarding the bank account and overdraft terms to the POS terminal. The method also includes transmitting an approval of the transaction to the POS terminal after receiving an acceptance by the debit card customer of the overdraft terms via the POS terminal. POS terminals are also disclosed.

### CROSS-REFERENCE TO RELATED APPLICATION

This application claims the benefit of U.S. Provisional Application No. 61/359,097, filed Jun. 28, 2010. The entire disclosure of the above application is incorporated herein by reference.

### FIELD

The present disclosure relates to systems and methods for obtaining debit card customer approval of overdraft fees.

### BACKGROUND

This section provides background information related to the present disclosure which is not necessarily prior art.

Point-of-sale (POS) terminals allow customers to pay for purchases using a wide variety of payment methods, such as with credit cards, debit cards, and gift cards and other prepaid cards, among others. Typically a terminal includes a card reader, a keypad, a display, additional reprogrammable keys surrounding the display, a printer, and a communication capability, e.g., a serial port, a parallel port, Ethernet, modem, a wireless transceiver, etc. The communication capability links the terminal to a POS system, such as a PC-based cash register, debit card network(s), etc. in a retail establishment so that a customer can use a card to pay for goods or services provided in the establishment. The POS system typically processes the payment by communication with the terminal and with a payment processor.

FIG. 1 illustrates a flow chart illustrating the flow of information and the various interfaces with the customer, debit card network, and the financial institution for an example POS transaction.

Financial institutions today have an algorithm by which they determine to overdraft a customer's account. These algorithms vary and are unique to each financial institution. Prior to the changes in Regulation E banks were allowed, and did, overdraft customers' accounts without their knowledge or consent. When a transaction occurred whereby the debit request back to the customer's financial institution was processed and found to exceed the customer's balance, the financial institution's algorithm/methodology would review the customer's situation and could choose to pay the overdraft. The financial institution could authorize to pay the overdraft at the POS, advance the proceeds, and charge an overdraft fee to the customer's account. The customer was not aware of the overdraft and fee at the time of sale. Therefore, the customer could continue to unknowingly overdraft the account and accumulate more fees before becoming aware of the situation.

The law (specifically, Regulation E of the Federal Reserve System) now requires the customer to opt in to an overdraft program or the customer's financial institution will be required to deny the transaction.

The inventor has realized, and accordingly developed the methods, systems, POS devices, etc. disclosed herein, that this step (e.g., opting in to an overdraft program) could be avoided if the customer could approve each transaction on a one to one basis; both an overdraft of the account and the acceptance of the overdraft fee. The customer would then know all three pieces of financial information—their current balance, the amount to be overdrawn, and the overdraft fee. This proposed methodology will provide better service even to those debit card holders who opted in at their financial institution; further, open overdraft capabilities would be provided to all purchasing customers.

### SUMMARY

This section provides a general summary of the disclosure, and is not a comprehensive disclosure of its full scope or all of its features.

According to one aspect of the present disclosure, a method for approving a transaction requested by a debit card customer at a point of sale (POS) terminal when completion of the transaction will overdraft a bank account with which the debit card is associated and the debit card customer is permitted to overdraft the bank account is disclosed. The method includes transmitting a denial of the transaction to the POS terminal and transmitting an overdraft approval indication to the POS terminal. The method includes receiving an overdraft request from the debit card customer via the POS terminal and transmitting an overdraft approval and information regarding the bank account and overdraft terms to the POS terminal. The method also includes transmitting an approval of the transaction to the POS terminal after receiving an acceptance by the debit card customer of the overdraft terms via the POS terminal.

According to another aspect of the present disclosure, a point of sale (POS) terminal for completing a payment transaction is disclosed. The POS terminal includes an input for receiving information regarding a bank account with a financial institution from a customer, a display for displaying information to the customer, a processor, and memory for storing instructions. The instructions are operable to cause the processor to receive the bank account information from the customer, and request approval for payment of the payment transaction from the bank account. The instructions are also operable to cause the processor to send a request from the user to the financial institution for overdraft privileges if there are insufficient funds in the bank account for the payment transaction, and acquire customer acceptance of overdraft terms if the financial institution agrees to overdraft privileges.

According to yet another aspect, a point of sale (POS) terminal for completing a payment transaction includes memory containing software and a processor. The processor is configured by the software to provide a customer with an option to request overdraft privileges from an institution with which the customer has an account if the customer's account has insufficient funds to complete the payment transaction. The processor is configured by the software to provide terms for the overdraft privileges to the customer if overdraft privileges are approved by the institution, and transmit acceptance of the terms by the customer to the institution.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart illustrating the flow of information and the various interfaces with the customer, debit card network, and the financial institution for an example POS transaction

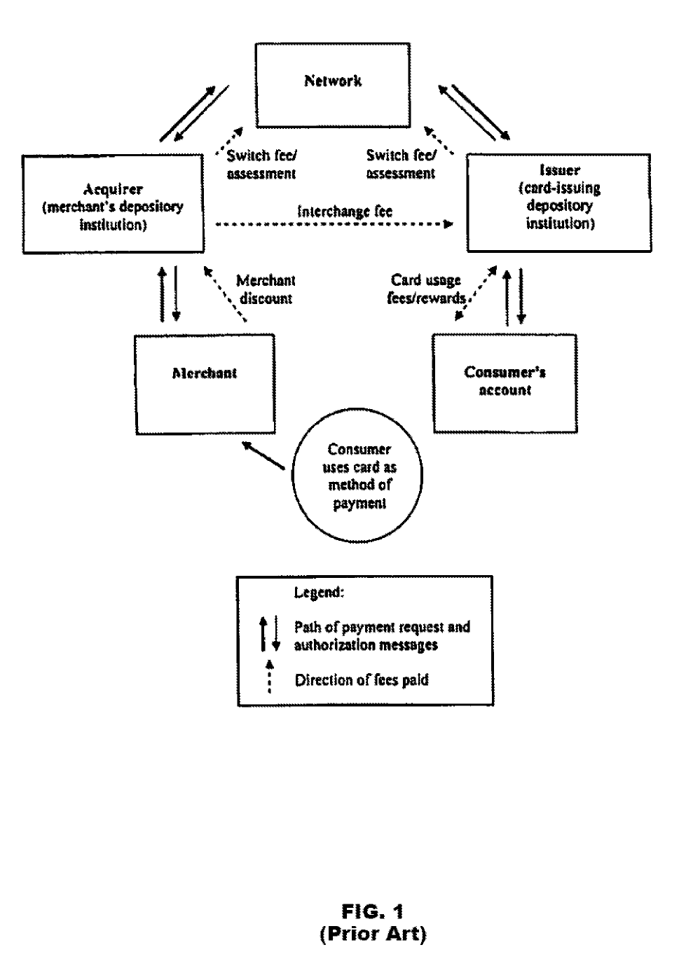

FIG. 2 is a flow chart illustrating the flow of information and the various interfaces with the customer, debit card network, and the financial institution for an example POS/UATM (Universal ATM) transaction according to one or more aspect of this disclosure.

FIG. 3 is a flow chart illustrating the flow of information and the various interfaces with the customer, debit card network, private network, and the financial institution for an example POS transaction involving a private network according to one or more aspect of this disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

According to one aspect of the present disclosure, a method for approving a transaction requested by a debit card customer at a point of sale (POS) terminal when completion of the transaction will overdraft a bank account with which the debit card is associated and the debit card customer is permitted to overdraft the bank account is disclosed. The method includes transmitting a denial of the transaction to the POS terminal and transmitting an overdraft approval indication to the POS terminal. The method includes receiving an overdraft request from the debit card customer via the POS terminal and transmitting an overdraft approval and information regarding the bank account and overdraft terms to the POS terminal. The method also includes transmitting an approval of the transaction to the POS terminal after receiving an acceptance by the debit card customer of the overdraft terms via the POS terminal.

In some embodiments, acceptance by the debit card customer of the overdraft terms includes a signature of the debit card customer. The POS device may operate as an ATM for the issuing financial institution of the debit card.

In some embodiments the overdraft terms include an amount of an overdraft fee. (Note: complies with New Reg. E)

According to another aspect of the present disclosure, a point of sale (POS) terminal for completing a payment transaction is disclosed. The POS terminal includes an input for receiving information regarding a bank account with a financial institution from a customer, a display for displaying information to the customer, a processor, and memory for storing instructions. The instructions are operable to cause the processor to receive the bank account information from the customer, and request approval for payment of the payment transaction from the bank account. The instructions are also operable to cause the processor to send a request from the user to the financial institution for overdraft privileges if there are insufficient funds in the bank account for the payment transaction, and acquire customer acceptance of overdraft terms if the financial institution agrees to overdraft privileges.

In some embodiments, the POS terminal further includes a signature input for receiving a signature of the customer. Customer acceptance of overdraft terms may include the customer's signature acquired via the signature input.

The instructions may be further operable to cause the processor to transmit the customer acceptance of the overdraft terms to the financial institution.

In some embodiments, the display may be a touch screen display. The touch screen display may include a signature input.

In at least one embodiment, the instructions are operable to cause the processor to request approval for payment of the payment transaction from the bank account via a first intermediary. The first intermediary may be, for example, a debit card network. The instructions may also be operable to cause the processor to send a request from the user to the financial institution for overdraft privileges if there are insufficient funds in the bank account for the payment transaction via a second intermediary.

According to yet another aspect, a point of sale (POS) terminal for completing a payment transaction includes memory containing software and a processor. The processor is configured by the software to provide a customer with an option to request overdraft privileges from an institution with which the customer has an account if the customer's account has insufficient funds to complete the payment transaction. The processor is configured by the software to provide terms for the overdraft privileges to the customer if overdraft privileges are approved by the institution, and transmit acceptance of the terms by the customer to the institution.

In some embodiments, the processor is configured by the software to acquire a signature of the customer as acceptance of the terms for the overdraft privileges.

The processor may be communicatively coupled to a printer for printing information for the customer. The POS terminal may include the printer, or the printer may be a separate printer.

The POS terminal may include a display device. The processor may be configured by the software to display the terms of the overdraft privileges to the customer on the display device. Additionally, or alternatively, the processor may be configured by the software to display additional information on the display device. The additional information may include a current account balance, an amount of the payment transaction, an account balance after completion of the payment transaction, etc.

In some embodiments, the processor is configured by the software to provide a customer with the option to request overdraft privileges from the institution only if the customer's account has insufficient funds to complete the payment transaction, the financial institution denies the payment transaction and the financial institution provides an indication that overdraft privileges may be requested.

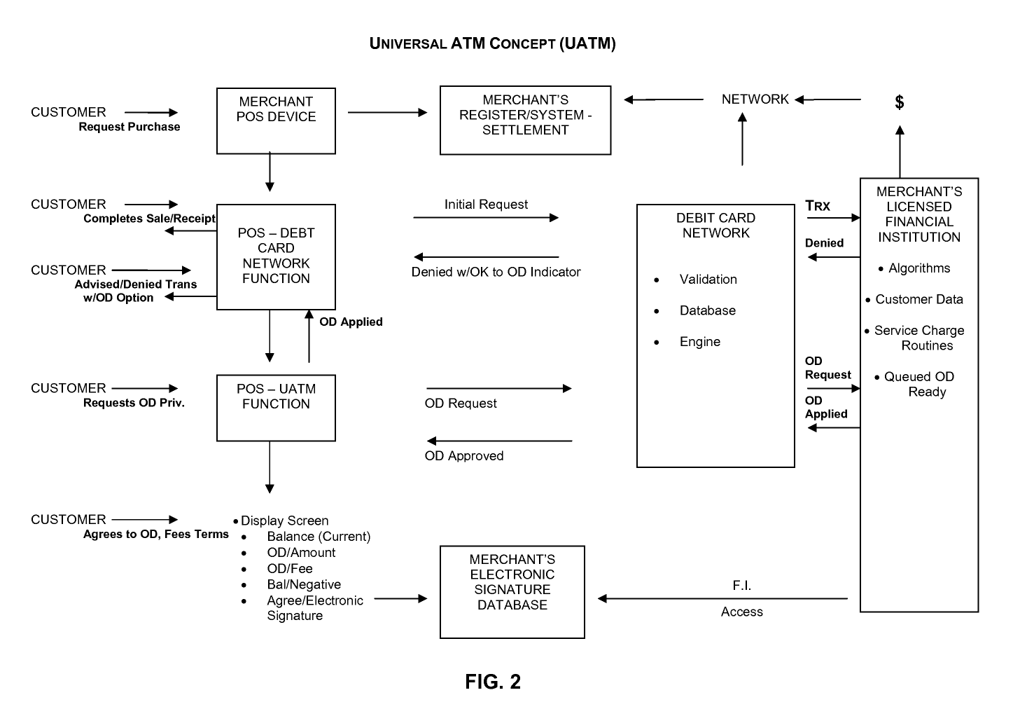

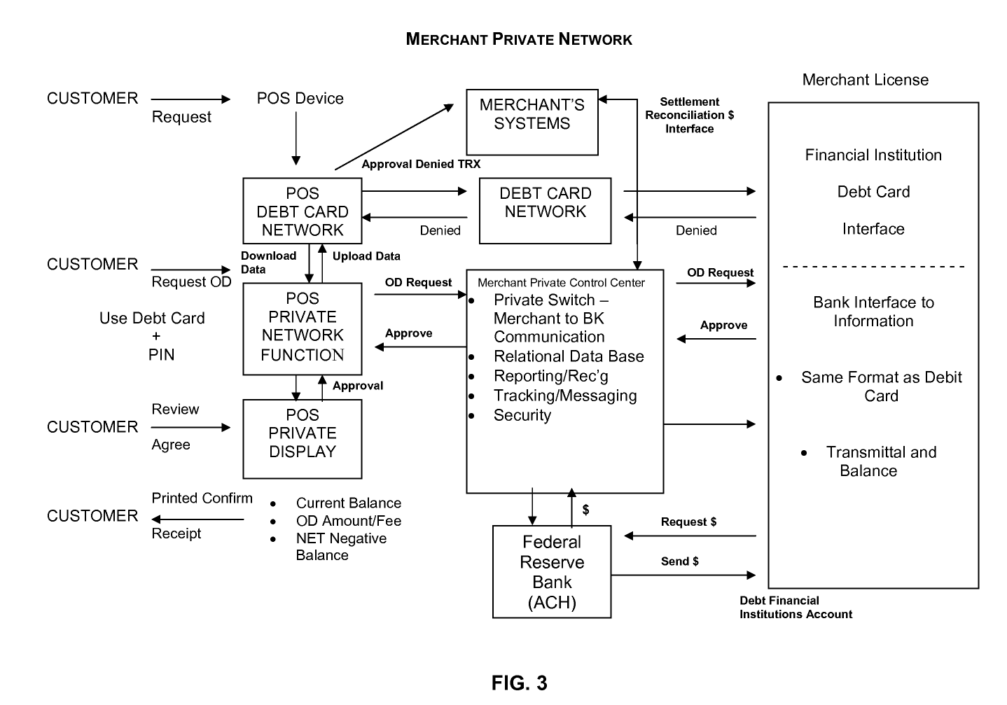

The aspects above will be further explained with reference to FIGS. 2 and 3.

FIG. 2 illustrates a flow chart illustrating the flow of information and the various interfaces with the customer, debit card network, and the financial institution for a Universal ATM (UATM) according to one or more aspect of this disclosure.

A Point of Sale (POS) device in retail stores may be used as a UATM. Currently the POS device at the merchant functions as a device that solely accesses a debit card network for validating balances at the point of sale. Disbursement of money is settled via the network. The UATM network concept adds a dual functionality to the POS device allowing the device to become essentially an ATM for the bank whose card the customer uses. This UATM concept is a real time interfacing like a standard ATM. The difference lies in that the UATM would essentially take over the POS device to serve multiple financial institutions the same as it does today in using the debit card network.

A POS device may become an ATM for one financial institution one moment and an ATM for another financial institution the next moment (e.g., when one customer completes a transaction involving a debit card from one financial institution and another customer completes a transaction involving a debit card from another financial institution). The merchant develops a standard protocol, agreement, and POS interface criteria for the financial institutions that choose to be affiliated with the merchant. This involves a three part technical process—the customer side, the terminal/network side, and the financial institutional side.

According to one or more aspects herein, the financial institution provides all of the information listed above (balances, fees, etc.) at the same time as the POS transaction request is received through the network if an overdraft were occurring due to this customer request. The financial institution's algorithm is accessed as usual, but the information about payment is now transmitted to the POS device at the merchant's location for display on the POS device, which is not operating as an ATM screen. The customer then, on a one on one basis, may be advised of the option to accept the financial institutions overdraft terms and conditions and agree to the overdraft and resultant fee in order to complete the sale.

If the customer agrees to accept the terms as displayed on the UATM, the customer may be required to provide a signature in order to authorize the overdraft. The signature may be captured electronically, by signing directly on electronic signature device (e.g. a signature block on a touchscreen display), by signing a paper agreement which is then scanned, etc. The screen may remain showing the various activities on the customer's account. The customer may be instantly issued/printed a receipt of the transaction via instructions from the program inside the POS device to an adjacent or attached printer.

The electronic signature may be stored in and electronic retrievable database by the merchant. The signature may be retrieved by the financial institution by providing locator number to the database. This would only be needed if a problem arose with the customer. Alternatively, or additionally, the electronic signature may be transmitted to the financial institution with or without storing the electronic signature in a database by the merchant.

By operating in this manner, the POS device becomes an ATM terminal of the financial institution, then complies with Regulation E, and subsequently communicates to the POS device in the debt card network to accept the customer request for purchase. The POS device with the authorization of the financial institution then operates as usual and completes the sale and settlement process.

At the time the customer request for purchase is denied through the debt card network the financial institution may indicate to the POS device the opportunity for the financial institution to pay the overdraft. The POS device asks the customer if they would like to inquire through the UATM about the option for completing the transaction through an overdraft process. Checking yes to this question places the POS device in UATM mode. The customer may then be required to enter his or her Personal Identification Code (PIN) into the UATM, thereby identifying the customer to the financial institution. Alternatively, the customer may not need to enter his/her PIN if the PIN was already entered in the normal course of business. This information flow is transferred within seconds as it is already in queue ready to deliver from the financial institution's database. The split second speed allows the customer immediate access for a decision by providing all of the necessary information. The customer's agreement to continue will immediately authorize the debit transaction and complete the sale at the merchant's location.

POS terminals today are in effect mini computers that may contain storage/memory, an operating language/system, communication devices to printers and networks, etc.

POS devices according to the present disclosure are programmed to perform the dual duties discussed above, i.e. to function as a POS device and function as an UATM. When functioning as UATM's thousands of POS terminals may be interacting with thousands of different banks in real time—instantly and simultaneously. POS terminals vary significantly in terms of makes, configurations, and memory capacity. As a result each particular type of POS terminal may require different programming. Significant architecting is required for an overall solution to permit these varied POS terminals to interact with various financial institutions.

Access to the banking network (e.g., when functioning as a UATM) may also extend the ability for the merchant to develop agreements with financial institutions to access additional credit line requests via the customer's credit card, or use funds in related accounts via bank internal transfer, etc. on behalf of the customer. Many financial institutions also have algorithms/programs to extend addition credit lines to existing customers. The expanded capability here would provide the customer with an option to ask in real time for this service. The same logic could be applied as the debit card approach earlier described.

The POS terminals according to the present disclosure may include self service, stand alone POS terminals that act solely as a UATM. Placing an unmanned POS device acting in the sole capacity as an UATM inside a merchant's location and using the same rails and adaptive technology provide the customer with the ability to check balances and request, if desired, overdraft privileges. This may be beneficial as the customer may request a larger overdraft capability, which would prevent other numerous overdraft charges for a period ahead. This process may also speed the connection and payment at the merchants counter as only the POS device will be needed. This may also save the customer the embarrassment of being rejected or taking extra time in the payment process, which may also be advantageous to the merchant because it may speed up completion of the transaction. The POS device could be developed to print out confirmation number to be used in the payment/POS transaction to tie the sale to the merchant's store. The customer using the PIN, swiping the card, and accessing the account at the financial institution could also see balances and the like for view or print.

The POS terminals according to this disclosure may also be used in self-service checkout environments in which the customer scans items and pays via self service. This technology is now emerging as an enhanced advantage to merchants in reducing labor costs.

Many stores have ATM machines located on premise. The current way this works requires a merchant's customer to pay a fee for balance inquiry at the ATM if the customer is not a customer of the bank who owns the terminal (e.g., a foreign ATM fee). Using the UATM process and licensing agreement between financial institutions the ATM may not be required for balance inquiry. POS devices according to this disclosure may be used to both reduce costs for customers via merchant negotiations with financial institutions who would like to continue providing overdrafts to its customers through UATM licensees. Cash may also be dispensed, if needed, to the customer by the merchant at the point of sale using the UATM process. The financial institution may then be solely responsible for risks concerning the cash disbursement. The merchant is then repaid for the cash transaction through the normal POS settlement process.

POS devices according to this disclosure may be used in a private network environment as an alternative to the debt card network approach currently in use and accomplish the same results as illustrated in FIG. 3. Essentially, when a POS transaction is denied through the debt card network, the information already collected during the transaction is downloaded into a POS private network function located within the POS device. Upon customer request to ask for overdraft privileges, the data is transmitted from the POS private network function to a merchant owned control center. This control center is a separate development by the merchant.

The merchant control center may act as an interface of technology between the technology that exists within the POS operating system/language and the language and protocol that the customer's financial institution uses. This switch may hold/collect all the needed information within a relational database to administer various functions, such as reporting/electronic funds transfers (ACH), accounting for its own systems, security, tracking data, etc. The merchant control center transmits the customer request to the customer's bank. This transmission and interface is developed with the various financial institutions. The request for an overdraft, fees, approval, balances, etc. would be passed back to the POS terminal for approval.

The Private Network POS function may display the information in the same way suggested above on the POS device for customer agreement. The merchant collects the monies due from the financial institution through the well established commercial banking practices using the Federal Reserve System via ACH mechanism. In effect, a private network bypasses the debit card network and related fees charged to the merchant and ultimately allows the merchant to negotiate directly with the financial institution. The merchant may, for example, use its transaction volume to reduce overdraft fees charged by the financial institution to its customers.

Methods and POS devices of the present disclosure may also be used in a stored value card environment. Merchants are currently selling stored value cards (e.g. gift cards, etc.) to customers or loading balances on cards for various uses—gifts, transfer payments, etc. An account/market for the merchant for the so called “unbanked” customers may be developed in accordance with this disclosure. Those who, for whatever reason, do not have, and in many cases cannot obtain, a banking relationship, may be developed by the merchant. The overall effect is to create banking type customers from the “unbanked” category using stored value cards.

This development uses the private network concept and private control center concept to provide the “unbanked” with records that show where, when, and how their money was spent, transaction history, and current balances via the merchant's own POS system. As the merchant can provide nearly all the basic needs that the customer may wish to purchase or can affiliate with others that can satisfy all the basics, all of the monies on the card will be spent with the merchant—a great competitive advantage for the merchant. With the system the merchant can also even provide cash back as the monies on the card are in a controlled environment at the time of the loading of the reloadable card. Many functions and marketing angles can be implemented using the private network store value card approach—even points (rewards or frequent purchases for usage could be tracked by type of transaction, etc.).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for approving a transaction requested by a debit card customer at a point of sale (POS) terminal when completion of the transaction will overdraft a bank account with which the debit card is associated and the debit card customer is permitted to overdraft the bank account, the method comprising:
transmitting a denial of the transaction to the POS terminal;
transmitting an overdraft approval indication to the POS terminal;
receiving an overdraft request from the debit card customer via the POS terminal;
transmitting an overdraft approval and information regarding the bank account and overdraft terms to the POS terminal; and
transmitting an approval of the transaction to the POS terminal after receiving an acceptance by the debit card customer of the overdraft terms via the POS terminal.

2. The method of claim 1, wherein the acceptance by the debit card customer of the overdraft terms includes a signature of or recorded acceptance by the debit card customer.

3. The method of claim 1 wherein the overdraft terms include an amount of an overdraft fee.

4. A point of sale (POS) terminal for completing a payment transaction, the POS terminal comprising:
an input for receiving information regarding a bank account with a financial institution from a customer;
a display for displaying information to the customer;
a processor; and
memory for storing instructions operable to cause the processor to:
receive the bank account information from the customer;
request approval for payment of the payment transaction from the bank account;
send a request from the user to the financial institution for overdraft privileges if there are insufficient funds in the bank account for the payment transaction; and
acquire customer acceptance of overdraft terms if the financial institution agrees to overdraft privileges.

5. The POS terminal of claim 4 further comprising a signature input for receiving a signature of the customer and wherein customer acceptance of overdraft terms includes the customer's signature acquired via the signature input.

6. The POS terminal of claim 5 wherein the instructions are further operable to cause the processor to transmit the customer acceptance of the overdraft terms to the financial institution.

7. The POS terminal of claim 5 wherein the display is a touch screen display and the touch screen display includes the signature input.

8. The POS terminal of claim 4 wherein the instructions are operable to cause the processor to request approval for payment of the payment transaction from the bank account via a first intermediary.

9. The POS terminal of claim 8 wherein the instructions are operable to cause the processor to send a request from the user to the financial institution for overdraft privileges if there are insufficient funds in the bank account for the payment transaction via a second intermediary.

10. The POS terminal of claim 8 wherein the first intermediary is a debit card network.

11. A point of sale (POS) terminal for completing a payment transaction, the POS terminal comprising:
memory containing software and a processor;
the processor configured by the software to provide a customer with an option to request overdraft privileges from an institution with which the customer has an account if the customer's account has insufficient funds to complete the payment transaction, provide terms for the overdraft privileges to the customer if overdraft privileges are approved by the institution, and transmit acceptance of the terms by the customer to the institution.

12. The POS terminal of claim 11 wherein the processor is configured by the software to acquire a signature of the customer as acceptance of the terms for the overdraft privileges.

13. The POS terminal of claim 11 wherein the processor is communicatively coupled to a printer for printing information for the customer.

14. The POS terminal of claim 13 further comprising the printer.

15. The POS terminal of claim 11 further comprising a display device and wherein the processor is configured by the software to display the terms of the overdraft privileges to the customer on the display device.

16. The POS terminal of claim 15 wherein the processor is configured by the software to display additional information on the display device.

17. The POS terminal of claim 16 wherein the additional information includes at least one of a current account balance, an amount of the payment transaction and an account balance after completion of the payment transaction.

18. The POS terminal of claim 11 the processor is configured by the software to provide a customer with the option to request overdraft privileges from the institution only if the customer's account has insufficient funds to complete the payment transaction, the financial institution denies the payment transaction and the financial institution provides an indication that overdraft privileges may be requested.

19. A point of sale (POS) terminal for completing a payment transaction between a customer and a merchant, the POS terminal comprising:
a processor and memory containing software;
the processor configured by the software to:
store information collected during a payment transaction in a POS private network function;
transmit to a merchant control center a request by the customer for overdraft privileges when the customer's financial institution denies completion of the transaction because of insufficient funds and the customer requests overdraft privileges;
transmit the stored information to the merchant control center; and
receive an approval or denial of the overdraft privileges after the merchant control center has communicated the request by the customer for overdraft privileges to the customer's financial institution and received a reply to the request from the customer's financial institution.
